(19) United States
(12) Patent Application Publication
(10) Pub. No.: US 2023/0130251 A1
(43) Pub. Date: Apr. 27, 2023

(54) LEVER SWITCH DEVICE

(71) Applicant: KABUSHIKI KAISHA TOKAI RIKA DENKI SEISAKUSHO, Aichi (JP)

(72) Inventors: Masane FUNAHASHI, Aichi (JP); Nobuyuki ISHIGURE, Aichi (JP); Tadashi USUYA, Aichi (JP); Yuki SATO, Aichi (JP)

(21) Appl. No.: 17/913,306

(22) PCT Filed: Mar. 11, 2021
(86) PCT No.: PCT/JP2021/009935

§ 371 Date: Sep. 21, 2022

(30) Foreign Application Priority Data
Mar. 26, 2020 (JP) 2020-056274

(51) Int. Cl. B60S 1/08; B60R 16/023; H01H 25/04

(52) U.S. Cl. CPC B60S 1/0818; B60S 1/0803; B60R 16/023; H01H 25/04

(57) ABSTRACT

A lever switch device which is configured to be connected to a support body in a vehicle. The lever switch device includes a rotatable operating lever, a switch structure including setting positions and allowing wiper operation setting to be made by rotation of the operating lever, and a structure of a detent mechanism to cause the operating lever to stay in a predetermined position. The setting positions include a home position, a position for wiper operation up adjustment and a position for wiper operation down adjustment. The detent mechanism includes a mechanism to return the operating lever to the home position from the position for wiper operation up adjustment or the position for wiper operation down adjustment.

### CROSS-REFERENCES TO RELATED APPLICATIONS

The present patent application claims the priority of Japanese patent application No. 2020/056274 filed on Mar. 26, 2020, and the entire contents of Japanese patent application No. 2020/056274 are hereby incorporated by reference.

### TECHNICAL FIELD

The present invention relates to a lever switch device including an operating lever.

### BACKGROUND ART

A lever switch device is used for commanding wipers to operate in MIST, OFF, AUTO, LO, and HI modes. The lever switch device is described in Patent Literature 1 and Patent Literature 2.

The lever switch device described in Patent Literature 1 includes a lever to select an operating mode including automatic operation, a light rain dial provided on the lever to adjust sensitivity of a rain sensor used for the automatic operation at the time of light rain, and a heavy rain dial provided on the lever to adjust sensitivity of the rain sensor used for the automatic operation at the time of heavy rain.

The lever switch device described in Patent Literature 2 includes a momentary switch including a lever that returns to a neutral position except when tilt-operated, a push switch which is provided on the lever and on which a push operation and a long push operation can be performed, and a switching means that switches the automatic operation based on a rain sensor between on and off when push-operated. The switching means, when long push operation is performed, switches to a mode in which intermittent operation can be turned on or turned on/off, and also switches to a temporary operation based on a tilt operation of the lever to a predetermined position other than the neutral position.

The lever switch device can realize a more user-friendly operation feeling. It is also possible to appropriately increase the degree of freedom of choice for drivers.

### CITATION LIST

### Patent Literatures

### Patent Literature 1: JP 2011/152822 A

### Patent Literature 2: JP 2011/143862 A

### SUMMARY OF INVENTION

### Technical Problem

However, the lever switch devices disclosed in Patent Literature 1 and Patent Literature 2 are configured to adjust AUTO sensitivity by rotating the dial switches provided on the lever, and thus may cause a problem that the lever is thick and there is a concern that it may come into contact with nearby components.

It is an object of the invention to provide a lever switch device that can avoid contact with nearby components.

### Solution to Problem

According to an embodiment of the invention, a lever switch device which is configured to be connected to a support body in a vehicle and comprises:
a rotatable operating lever;
a switch structure comprising setting positions and allowing wiper operation setting to be made by rotation of the operating lever; and
a structure of a detent mechanism to cause the operating lever to stay in a predetermined position,
wherein the setting positions comprise a home position, a position for wiper operation up adjustment and a position for wiper operation down adjustment, and
wherein the detent mechanism comprises a mechanism to return the operating lever to the home position from the position for wiper operation up adjustment or the position for wiper operation down adjustment.

### Advantageous Effects of Invention

According to an embodiment of the invention, a lever switch device can be provided that can avoid contact with nearby components.

### BRIEF DESCRIPTION OF DRAWINGS

FIG. 1A is an explanatory diagram illustrating a vehicle interior in front of a driver's seat of a vehicle on which lever switch devices in the first embodiment of the present invention are mounted.

FIG. 1B is an explanatory diagram illustrating the area around a lever combination switch in the first embodiment and therearound when viewed from the front.

FIG. 2 is a perspective view showing the lever switch device in the first embodiment of the invention.

FIG. 3 is a block diagram illustrating a system of the lever switch device in the first embodiment of the invention.

FIG. 4A is an external view showing an operating lever and a mode switching unit of the lever switch device in the first embodiment of the invention in a state in which no mode switching operation is performed.

FIG. 4B is an external view showing the operating lever and the mode switching unit of the lever switch device in the first embodiment of the invention in a state in which a mode switching operation is being performed.

FIG. 5A is an explanatory diagram illustrating an “OFF” setting position in the first embodiment of the invention, as a switch setting position for wiper operation according to an angle of the operating lever of the lever switch device.

FIG. 5B is an explanatory diagram illustrating a sensitivity “+” setting position in an AUTO mode in the first embodiment of the invention, as a switch setting position for wiper operation according to an angle of the operating lever of the lever switch device.

FIG. 5C is an explanatory diagram illustrating a sensitivity “−” setting position in the AUTO mode in the first embodiment of the invention, as a switch setting position for wiper operation according to an angle of the operating lever of the lever switch device.

FIG. 5D is an explanatory diagram illustrating a “LO” setting position in the first embodiment of the invention, as a switch setting position for wiper operation according to an angle of the operating lever of the lever switch device.

FIG. 5E is an explanatory diagram illustrating a “HI” setting position in the first embodiment of the invention, as a switch setting position for wiper operation according to an angle of the operating lever of the lever switch device.

FIG. 6 is an explanatory diagram illustrating a relationship between wiper operation and a rainfall signal from a rain sensor of the lever switch device in the first embodiment of the invention.

FIG. 7 is a flowchart of the AUTO mode of the lever switch device in the first embodiment of the invention.

FIG. 8 is an explanatory block diagram illustrating wiper operation settings of the lever switch device in the first embodiment of the invention and how to operate.

FIG. 9 is an explanatory block diagram illustrating wiper operation settings of the lever switch device in the second embodiment of the invention and how to operate.

FIG. 10 is an explanatory block diagram illustrating wiper operation settings of the lever switch device in a modification of the second embodiment of the invention and how to operate.

### DESCRIPTION OF EMBODIMENTS

### First Embodiment

### (Overall Configuration in Front of Front Seats of a Vehicle)

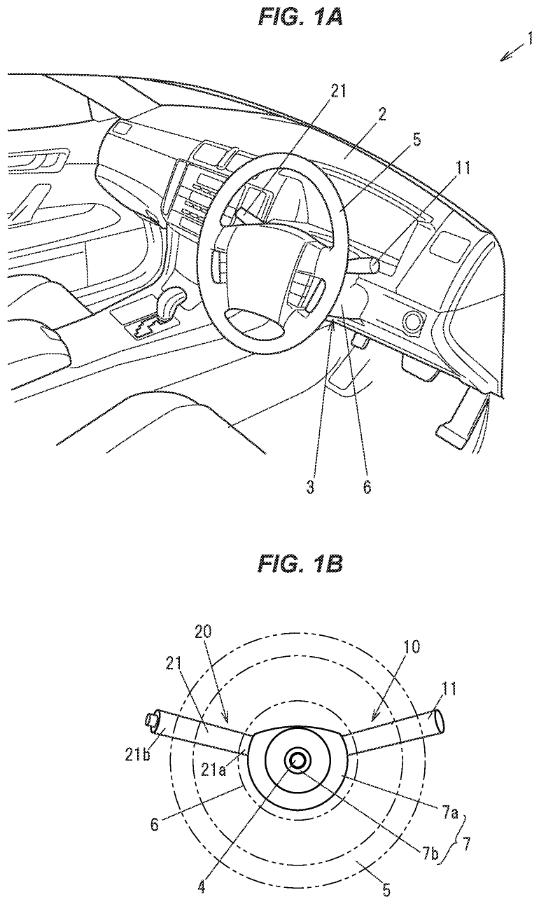

FIG. 1A is an explanatory diagram illustrating a vehicle interior in front of a driver's seat of a vehicle on which lever switch devices in the first embodiment of the invention are mounted, and FIG. 1B is an explanatory diagram illustrating the lever switch devices in the first embodiment and therearound when viewed from the front.

In FIG. 1A, a synthetic resin instrument panel 2, on which gauges and a front passenger airbag, etc., are installed, is arranged in front of the front seats of a vehicle 1 so as to extend in a vehicle width direction. A steering column 3 is located at a portion of the instrument panel 2 on the right side of the vehicle.

The steering column 3 includes a steering shaft 4 shown in FIG. 1B and a column post (not shown) covering the outer periphery of the steering shaft 4. A mounting-fixing portion 7 is then attached and fixed to the column post in a state in which the steering shaft 4 is inserted into a steering shaft insertion portion 7b. In addition, a steering wheel 5 is integrally rotatably supported at an end portion of the steering shaft 4 extending from the column post.

A lighting-system lever switch device 10 to operate turn signal lamps, headlamps and fog lamps, etc., and a wiper-system lever switch device 20 to operate wipers and washers, etc., are connected and fixed to a main body 7a of the mounting-fixing portion 7 serving as a support body and are provided on both left and right sides of the steering shaft 4. A lighting-system operating lever 11 of the lighting-system lever switch device 10 and a wiper-system operating lever 21 of the wiper-system lever switch device 20 are arranged to protrude from a steering column cover 6 covering the steering column 3 so that end portions thereof are located slightly outside the steering wheel 5.

The first embodiment will be described on the assumption that the vehicle is right-hand drive, and the wiper-system lever switch device 20 which protrudes on the left side and can operate the wipers and the washers will be mainly described (hereinafter, the wiper-system lever switch device 20 and the wiper-system operating lever 21 are simply referred to as the lever switch device 20 and the operating lever 21).

### (Configuration of the Lever Switch Device 20)

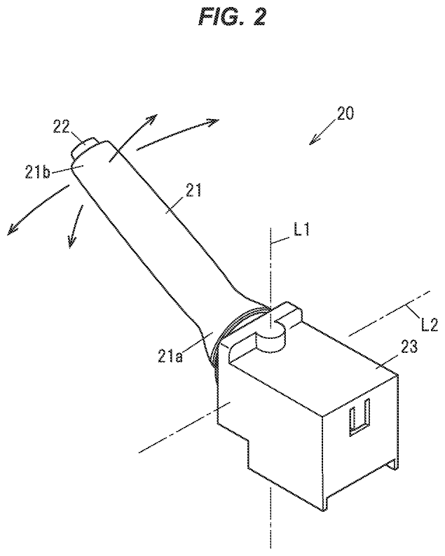

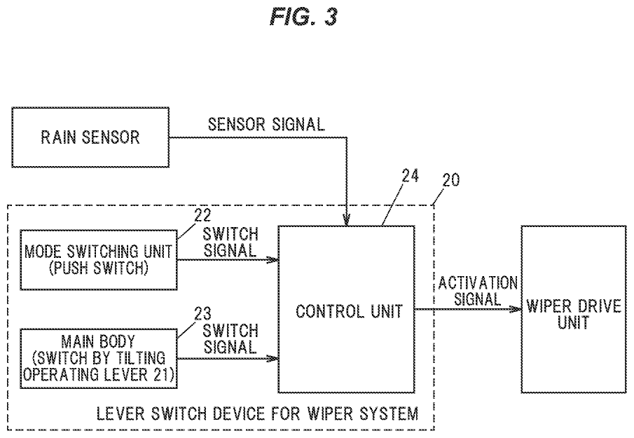

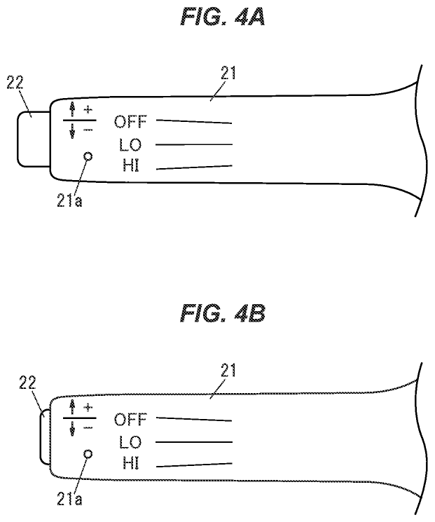

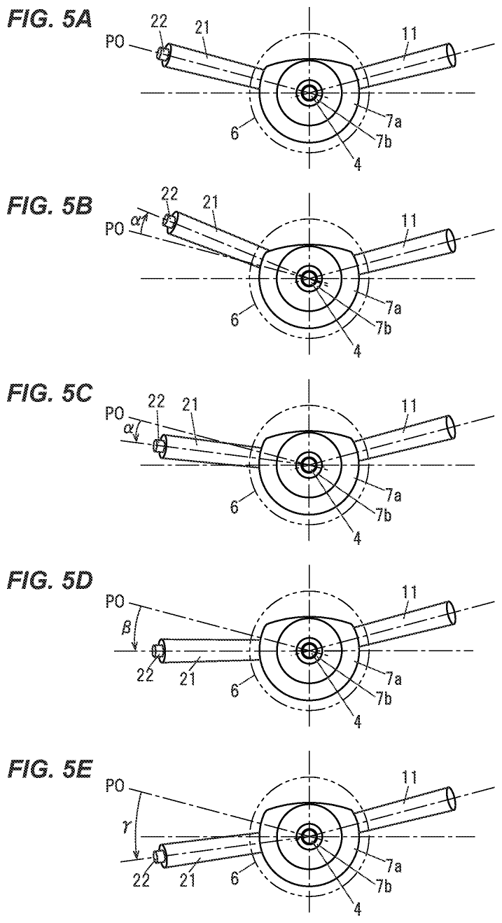

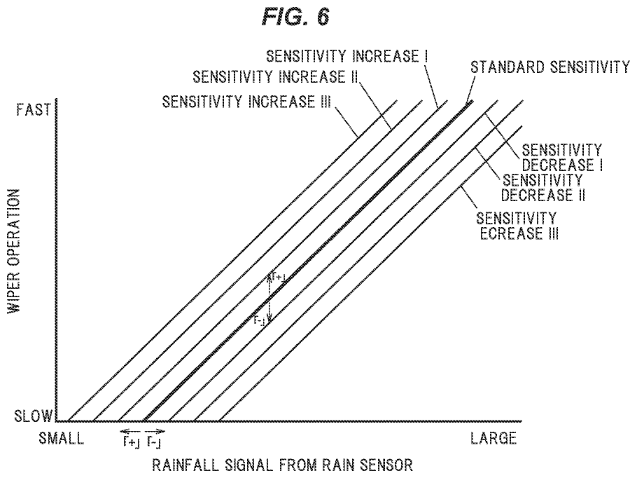

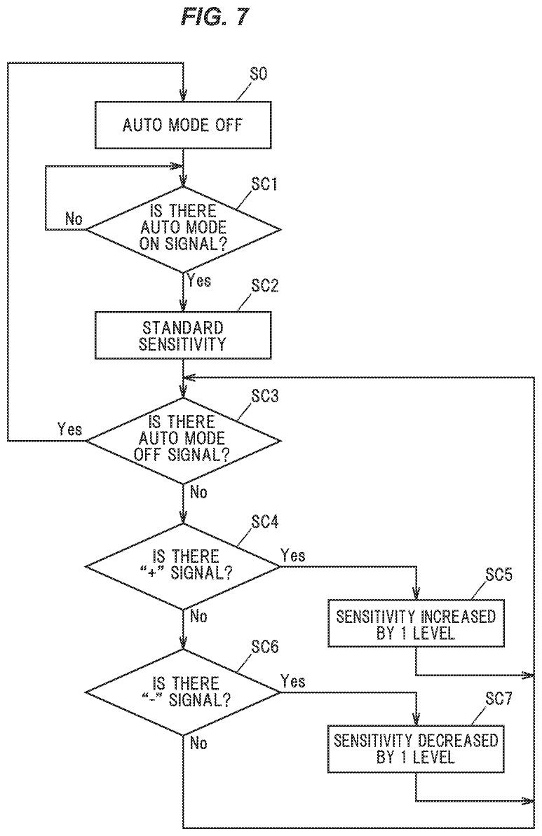

FIG. 2 is a perspective view showing the lever switch device in the first embodiment of the invention. FIG. 3 is a block diagram illustrating a system of the lever switch device in the first embodiment of the invention. FIGS. 4A and 4B are external views showing the operating lever and a mode switching unit of the lever switch device in the first embodiment of the invention, wherein FIG. 4A shows a state in which no mode switching operation is performed, and FIG. 4B shows the state in which a mode switching operation is being performed. FIGS. 5A, 5B, 5C and 5D are explanatory diagrams illustrating switch setting positions for wiper operation according to angles of the operating lever of the lever switch device in the first embodiment of the invention, wherein FIG. 5A shows an “OFF” setting position, FIG. 5B shows an AUTO mode sensitivity “+” setting position, FIG. 5C shows an AUTO mode sensitivity “−” setting position, FIG. 5D shows a “LO” setting position, and FIG. 5E shows a “HI” setting position. FIG. 6 is an explanatory diagram illustrating a relationship between wiper operation and a rainfall signal from a rain sensor of the lever switch device in the first embodiment of the invention. FIG. 7 is a flowchart of the AUTO mode of the lever switch device in the first embodiment of the invention.

FIG. 2 is a perspective view showing the lever switch device 20. The lever switch device 20 is composed of the operating lever 21, a mode switching unit 22, a main body 23, and a control unit 24. As shown in FIG. 3, the lever switch device 20 is configured such that the control unit 24 sends an activation signal to a wiper drive unit based on a signal from the mode switching unit 22, a signal from the main body unit 23 by tilt of the operating lever 21, and a signal from the rain sensor.

As will be described later, the lever switch device 20 includes an AUTO (automatic) mode to automatically operate the wipers according to the rainfall state based on a signal from the rain sensor, and a manual mode in which the signal from the rain sensor is not used. In the AUTO mode, there is a setting to perform wiper operation at standard sensitivity relative to a rain sensor signal and settings with plural sensitivities (degrees of wiper operation relative to the rain sensor signal) to perform wiper operation adjusted relative to the wiper operation at standard sensitivity.

The operating lever 21 has a substantially columnar shape. An end portion 21a of the operating lever 21 on the steering shaft 4 side is connected to the main body 23 so as to be rotatable about a first rotation axis L1 as well as about a second rotation axis L2 substantially orthogonal to the first rotation axis L1. The operating lever 21 also includes an indicator lamp 21c that is provided near an end portion and indicates the state of the mode. The mode switching unit 22 is attached to another end portion 21b of the operating lever 21.

The main unit 23 includes a rotation mechanism to allow the operating lever 21 to rotate about the first rotation axis L1 and about the second rotation axis L2 substantially orthogonal to the first rotation axis L1, a switch to set wiper operation, a detent mechanism to cause the operating lever 21 to stay in a predetermined position or to return to the predetermined position, and a case to house these components. Meanwhile, since the configuration of contacts and terminals of the switch and the configurations of the rotation mechanism and the detent mechanism are well known, detailed descriptions and illustrations are omitted. In addition, a mechanical contact type will be described in the embodiment, but it may be an electromagnetic non-contact type.

Next, a switch of the mode switching unit 22 and the switch of the main body 23 by means of tilt of the operating lever 21 will be described. Table 1 shows a list of switches provided in the lever switch device 20.

TABLE 1

| Operating | | | Specification | Switch | Wiper operation | Operation |
|---|---|---|---|---|---|---|
| portion | How to operate | Switch position | in position | setting | setting | mode |
| Mode | Press down | Protruding | Alternate | “Maintain” | AUTO mode | AUTO mode |
| switching | Push switch | | | | Maintain the | |
| unit 22 | | | | | current state | |
| | | Not protruding | Momentary | “Switching” | AUTO mode | |
| | | | | | Switching | |
| Operating | Tilt about First | Angle α upward | Momentary | “+” | AUTO sensitivity | |
| lever 21 | rotation axis L1 | from PO | | | One level up | |
| | | Home position: PO | Alternate | “OFF” | Maintain the | |
| | | | | | current state | |
| | | Angle α downward | Momentary | “−” | AUTO sensitivity | |
| | | from PO | | | One level down | |
| | | Angle β downward | Alternate | “LO” | Low-speed | Manual |
| | | from PO | | | operation | mode |
| | | Angle γ downward | Alternate | “HI” | High-speed | |
| | | from PO | | | operation | |
| | Tilt about Second | Angle θ from PO | Momentary | “MIST” | Single operation | |
| | rotation axis L2 | toward the far side | | | | |
| | | Home position: PO | Alternate | “OFF” | “OFF” | |
| | | Angle θ from PO | Momentary | “Wash” | Washer operation | |
| | | toward the near side | | | | |

The mode switching unit 22 is a momentary push switch having two setting positions to set the AUTO mode to ON/OFF. That is, when no mode switching operation is performed, the switch of the mode switching unit 22 is maintained in the protruding state (alternate), as shown in FIG. 4A. Then, when a driver pushes the protruding switch in an axial direction of the operating lever 21, the switch of the mode switching unit 22 is placed into a non-protruding state as shown in FIG. 4B, and the AUTO mode is switched ON/OFF. In other words, the AUTO mode is turned “ON” when performing the mode switching operation in the “OFF” state and is turned “OFF” when performing the mode switching operation in the “ON” state. Then, when the driver lifts the hand off the switch, the switch of the mode switching unit 22 returns to the protruding state shown in FIG. 4A (momentary).

FIGS. 5A to 5E show five setting positions of the switch of the main body 23 which are set by tilt of the operating lever 21 about the first rotation axis L1.

In FIG. 5A, the operating lever 11 on the right side is in an “OFF” setting position of the lighting-system switch, and the operating lever 21 on the left side is in an “OFF” setting position of the wiper-system switch. This position is a home position: PO. This home position is where the driver can easily operate the operating lever 11 and the operating lever 21 from the common positions of holding the steering wheel. Furthermore, the operating lever 11 and the operating lever 21 at this position can be easily seen by the driver. The operating lever 11 and the operating lever 21 are symmetrical and well balanced.

The “OFF” setting for the wiper-system switch is a setting to stop wiper operation when in the manual mode (when the AUTO mode is “OFF”). It is also a setting to maintain the current state and continue the currently selected setting when in the AUTO mode (when the AUTO mode is “ON”). In the AUTO mode, the operating lever 21 is in the home position except when adjusting sensitivity as described below.

FIG. 5B shows the “+” switch setting position at which the operating lever 21 is tilted upward by an angle α from the home position: PO. This setting position is a setting position of a switch used to adjust to increase sensitivity when in the AUTO mode. The adjustment to increase sensitivity changes to a program of increasing wiper operation by one level among plural levels, and it is possible to increase, e.g., a speed of wiper operation. This setting position is a momentary switch and it is a mechanism in which the operating lever 21 does not stay stably and returns to the home position by the detent mechanism when, e.g., the driver takes the hand off the operating lever 21.

FIG. 5C shows the “−” switch setting position at which the operating lever 21 is tilted downward by the angle α from the home position: PO. This setting position is a setting position of a switch used to adjust to decrease sensitivity when in the AUTO mode. The adjustment to decrease sensitivity changes to a program of decreasing wiper operation by one level among the plural levels, and it is possible to decrease, e.g., the speed of wiper operation. This position is a momentary switch and the operating lever 21 does not stay stably.

FIG. 5D shows the “LO” switch setting position at which the operating lever 21 is tilted downward by an angle β (α<β) from the home position: PO. “LO” is a setting to operate the wipers at low speed (45 times/min). The “LO” switch setting position is a position tilted from the home position in FIG. 5A beyond the “−” switch setting position of the momentary switch in FIG. 5C. This setting position is an alternate switch and it is configured to stably stay at this position when tilted beyond the “−” switch setting position against a force of the detent mechanism to return to the home position.

FIG. 5E shows the “HI” switch setting position at which the operating lever 21 is tilted downward by an angle γ (β<γ) from the home position: PO. “HI” is a setting to operate the wipers at high speed (70 times/min). This position is an alternate switch and it is configured to stably stay at this position by the detent mechanism.

The main body 23 also has three setting positions located about the second rotation axis L2 and corresponding to the tilt of the operating lever 21, which are: the home position which is the above-described “OFF” setting position of stable stay by the detent mechanism; a “MIST” switch setting position tilted by an angle θ toward the far side from the steering wheel as viewed from the driver (a direction toward the back of the paper in FIGS. 5A to 5E); and a “washer” switch setting position tilted by the angle θ toward the near side. The “MIST” and “washer” setting positions are momentary switches and the operating lever 21 does not stay in these setting positions.

The control unit 24 is, e.g., a microcomputer composed of a CPU (Central Processing Unit) performing calculation and processing, etc., of acquired data according to a stored program, and a RAM (Random Access Memory) and a ROM (Read Only Memory) as semiconductor memories, etc. The ROM stores, e.g., a program for operation of the control unit 24. The RAM is used as, e.g., a storage area to temporarily store detection information, etc.

The control unit 24 stores a program to detect the operated state of the operating lever 21 and the mode switching unit 22 by the driver, and a program to control wiper operation based on signals from them and a signal of the rain sensor.

A program of standard sensitivity wiper operation based on the rainfall signal from the rain sensor shown in FIG. 6 (baseline for wiper speed and whether or not to operate under very small rainfall conditions, etc.) and a program to control wiper operation at several sensitivity settings different from the standard sensitivity wiper operation are stored as AUTO mode programs.

The programs here are wiper operation settings with seven levels, from high to low in order of “Sensitivity Increase III”-“Standard Sensitivity”-“Sensitivity Decrease III”. The degree of wiper operation is high in the programs with high sensitivity settings. For example, wiper operation is initiated with a smaller rain sensor-rainfall signal, or the rain sensor-rainfall signal which is sufficient to perform a wiper operation is the same but wiper operation is faster. In this regard, FIG. 6 shows an example of seven-level wiper operation settings configured such that the rain sensor-rainfall signal and the wiper operation are in a proportional relationship and sensitivities are substantially equally spaced, but it is not limited thereto.

The control unit 24 also stores a program of the flow shown in FIG. 7 to turn the AUTO mode on/off and to increase/maintain/decrease the currently set sensitivity based on a switch signal from the mode switching unit 22 and a “+” or “−” switch signal from the main body 23 by tilt of the operating lever 21.

This flow starts from the AUTO mode “OFF” state in S0, and the control unit 24 checks whether there is an AUTO mode “ON” signal in SC1. When there is no signal, the control unit 24 repeats this check. When there is a signal, the setting is “Standard Sensitivity” in the AUTO mode in SC2.

Next, the control unit 24 checks the AUTO mode “OFF” signal in SC3, and if there is the signal, the AUTO mode is set to “OFF”. When there is no AUTO mode “OFF” signal, the control unit 24 checks a “+” signal in SC4. When there is a “+” signal, sensitivity is increased by one level in SC5. When there is no “+” signal, the control unit 24 checks a “−” signal in SC6. Then, when there is a “−” signal, sensitivity is decreased by one level in SC7. When there is no “−” signal, the flow returns to SC3. The flow also returns to SC3 after sensitivity is increased or decreased in SC5 or SC7.

### (Operation of the Lever Switch Device 20)

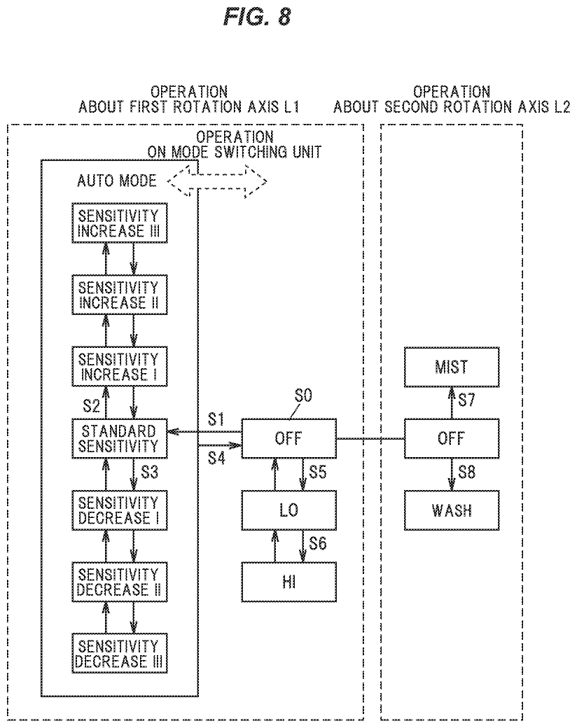

FIG. 8 is an explanatory block diagram illustrating wiper operation settings of the lever switch device in the embodiment of the invention and how to operate.

S0 is an initial state in which no wiper operation is performed. The position of the operating lever 21 is the home position. The setting of the mode switching unit 22 is “OFF”.

S1 is an operation to set the AUTO mode to “ON” from “OFF” by pressing the push switch of the mode switching unit 22. This operation activates the AUTO mode, and wiper operation with “Standard Sensitivity” is performed based on information from the rain sensor. For example, the rain sensor senses the intensity of rainfall, and if the rainfall is not less than a predetermined baseline for standard sensitivity, wiper operation is performed at a speed corresponding to the intensity of rainfall. In addition, when the AUTO mode is set, the indicator lamp 21c provided near the end portion of the operating lever 21 is lit to indicate that the AUTO mode is “ON”.

The mode switching operation is an operation of pressing the push switch of the mode switching unit 22 at the end portion of the operating lever 21 in the home position, with a finger of the left hand. The driver can easily perform an operation while placing the hands on the steering wheel.

S2 and S3 are operations to adjust wiper operation according to the driver's preference, driving conditions, or rain/snow conditions, etc. S2 is an operation to increase the sensitivity level setting by tilting the operating lever 21 about the first rotation axis L1 to the “+” setting position. On the other hand, S3 is an operation to decrease the sensitivity level setting by tilting the operating lever 21 about the first rotation axis L1 to the setting position.

For example, performing the operation S2 once from the “Standard Sensitivity” setting changes to the “Sensitivity Increase I” setting. The baseline for whether or not to perform wiper operation is then lowered and the setting is changed to perform wiper operation with a smaller amount of rainfall. In this setting, the speed of wiper operation according to the intensity of rainfall is also faster. On the other hand, performing the operation S3 once from the “Standard Sensitivity” setting changes to the “Sensitivity Decrease I” setting. The baseline for whether or not to perform wiper operation is then raised and the setting is changed to perform wiper operation with a larger amount of rainfall. In this setting, the speed of wiper operation according to the intensity of rainfall is also slower.

In this regard, the operating lever 21 is in the home position before the tilt operation, and returns to the home position when taking the hand off after the tilt operation.

The sensitivity level adjustment can also be performed in multiple stages by repeating the operation S2 or S3 several times. For example, repeating the operation S2 three times from the “Standard Sensitivity” changes the setting to the “Sensitivity Increase III”. Likewise, for example, repeating the operation S3 three times from the “Sensitivity Increase II” changes the setting to the “Sensitivity Decrease I”.

At the time of repeating the operation S2 or S3 several times, the operation may be performed in such a manner that the operating lever 21 is let to return to the home position and then the operation S2 or S3 is performed again. Alternatively, the operation may be performed in such a manner that, after the operating lever 21 left the “+” or “−” setting position and before it returns to the home position, the plural operations are performed all at once in a short period of time. This is the case where there are multi-level settings and plural operations are performed in one direction using a detent mechanism.

S4 is an operation to set the AUTO mode to “OFF” from “ON” by the mode switching unit 22. This terminates the AUTO mode, thereby returning to the initial state S0 in which the wipers are not operated. The indicator lamp 21c provided near the end portion of the operating lever 21 is then turned off. In this regard, the mode switching unit 22 can be operated at any sensitivity level setting of the AUTO mode.

S5 is an operation to perform low-speed wiper operation by tilting the operating lever 21 about the first rotation axis L1 to the “LO” setting position. S6 is an operation to perform high-speed wiper operation by tilting the operating lever 21 about the first rotation axis L1 to the “HI” setting position. Even when the AUTO mode is “ON”, this wiper operation is performed when the operating lever 21 is tilted to the “LO” or “HI” setting position. The operating lever 21 stays in the “LO” or “HI” setting position after the tilt operation. To operate to another setting position, the operating lever 21 is tilted from this position.

S7 is an operation to perform one reciprocating wiper operation by tilting the operating lever 21 about the second rotation axis L2 to the “MIST” setting position on the far side from the driver. S8 is an operation to spray washer fluid and perform two reciprocating wiper operations by tilting the operating lever 21 about the second rotation axis L2 to the “wash” setting position on the near side of the driver. In this regard, the operating lever 21 is in the home position before the tilt operation, and returns to the home position when taking the hand off after the tilt operation.

### Effects of the First Embodiment of the Invention

The following effects are obtained in the embodiment of the invention described above.

Sensitivity adjustment in AUTO mode having many switch settings is performed by tilting the operating lever, and a rotary dial switch is not provided on the operating lever. This allows the operating lever to be thin. It is thus possible to avoid contact with nearby components. The design of the operating lever is also improved.

The sensitivity adjustment in the AUTO mode is configured such that plural settings to increase/decrease wiper operation can be selected in a stepwise manner by tilt operations in two directions about the same rotation axis. In addition, the operating lever includes the detent mechanism that causes the operating lever to return to the home position after the tilt operation performed to adjust sensitivity in the AUTO mode. This allows operation to match the driver's senses even though there are many switch settings of not less than three levels. In addition, the operating lever can be operated without taking the hand off the steering wheel, and in addition, the operating lever is always in an easy-to-operate position. The influence of an action of operating the wipers on driving can thus be suppressed.

The mode switching unit has been described as a momentary push switch with two setting positions in the first embodiment of the invention, but may be, e.g., an alternate switch or a seesaw switch. In addition, although the switch serving as the mode switching unit to turn ON/OFF the AUTO mode is provided at the end portion of the operating lever, the configuration is not limited thereto. For example, it may be installed in a spoke portion of the steering wheel, etc., within reach of the left thumb of the driver who is holding the steering wheel. The switch position is arbitrary, but is desirably a location where the driver can operate without taking the hand off the steering wheel. This allows the driver to perform all AUTO mode operations without taking the hand off the steering wheel.

In addition, the indicator lamp 21c, which is lit when the AUTO mode is “ON”, may be provided on a portion other than the operating lever. For example, an indicator portion to indicate the AUTO mode state may be provided on the steering wheel or an instrument panel portion. In addition, the indicator portion provided on the operating lever or another portion may be used to indicate not only the ON/OFF state of the AUTO mode but also the state of multi-level sensitivity settings.

In addition, the control unit 24 may be provided on the vehicle 1 instead of on the lever switch device 20.

In addition, in the first embodiment of the invention, when the upper limit of “Sensitivity Increase III” or the lower limit of “Sensitivity Decrease III” is reached, the sensitivity setting remains at the upper limit of “Sensitivity Increase III” or the lower limit of “Sensitivity Decrease III” even if S2: the operation to increase the sensitivity level setting or S3: the operation to decrease the sensitivity level setting is continuously performed. It is not limited thereto, and it may be a cycle operation method in which the setting is changed to the lower limit of “Sensitivity Decrease III” when the operating lever 21 at the upper limit of “Sensitivity Increase III” is tilted about the first rotation axis L1 to the “+” setting position (the setting is changed to the upper limit of “Sensitivity Increase II” when the operating lever 21 at the lower limit of “Sensitivity Decrease III” is tilted about the first rotation axis L1 to the “−” position). In this case, in addition to the same effects as in the first embodiment of the invention, it is easy to be aware of the upper/lower limit when the setting is the upper/lower limit.

The operating lever 21 may include a rotary switch for rear wiper. When providing the three setting positions of “OFF”, “LO” and “HI”, it is not necessary to use a large-diameter dial switch and the operating lever can be kept thin.

### Second Embodiment

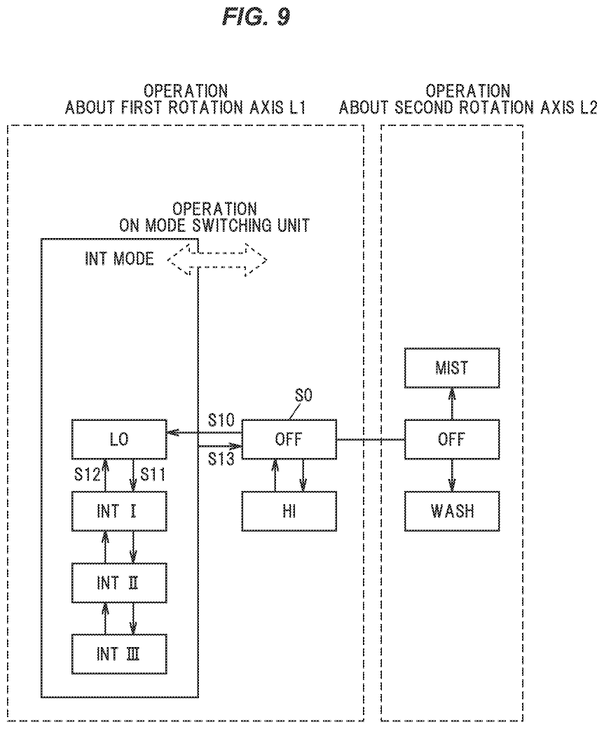

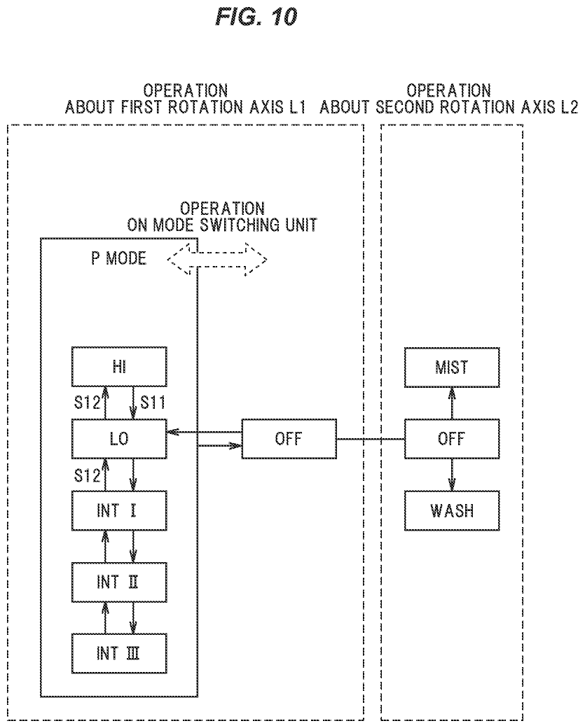

FIG. 9 is an explanatory block diagram illustrating wiper operation settings of the lever switch device in the second embodiment of the invention and how to operate. FIG. 10 is an explanatory block diagram illustrating wiper operation settings of the lever switch device in a modification of the second embodiment of the invention and how to operate.

The lever switch device 20 in the first embodiment is configured to adjust sensitivity in the AUTO mode based on the signal from the rain sensor. Meanwhile, the second embodiment is different in that wiper operation setting is made in an INT (intermittent operation) mode, etc., in which the signal from the rain sensor is not used. It is also different in that the number of switch setting positions of the main body 23 about the first rotation axis L1 of the operating lever 21 is reduced and the push switch of the mode switching unit 22 is of a momentary type instead of the alternate type. Next, configurations and operations different from the first embodiment will be mainly described.

The lever switch device 20 in the second embodiment has an INT (intermittent operation) mode, as shown in FIG. 9. The control unit 24 stores programs of “LO” wiper operation and “INT I”, “INT II” and “INT III” to control wiper operation at three levels with the operation time interval increasing in this order, in the INT mode. The operation settings are, e.g., 1-, 3-, and 6-second interval settings, but it is not limited to predetermined time intervals and a vehicle speed-sensing type to change interval time according to the speed of the vehicle may be used.

The main body 23 has four switch setting positions about the first rotation axis L1 of the operating lever 21. The switch setting position corresponding to the “HI” setting position in the first embodiment is omitted. Instead, a position corresponding to the “LO” setting position in the first embodiment, i.e., a position of the operating lever 21 when tilted downward by the angle β from the home position: PO is provided as the “HI” setting position.

In addition, the mode switching unit 22 is configured as a momentary push switch. That is, the TNT mode is switched between ON and OFF when the protruding switch is pushed in, and the pushed switch returns to the protruding state each time.

The INT mode is set to “ON” from “OFF” by an operation S10 of pressing the push switch of the mode switching unit 22 from the initial state S0 in which the wipers are not operated. This changes to the setting to perform “LO” wiper operation.

S11 and S12 are operations to adjust the time interval of wiper operation. S11 is an operation to change to a longer time interval by tilting the operating lever 21 about the first rotation axis L1 to the “−” setting position. S12 is an operation to change to a shorter time interval by tilting the operating lever 21 about the first rotation axis L1 to the “+” setting position. In addition, the time interval can be adjusted in multiple stages by repeating this operation several times. For example, repeating the operation S11 three times from the “LO” setting changes to the “INT III” setting. Meanwhile, repeating the operation S12 three times from the “INT III” setting changes to the “LO” setting.

The INT mode is set to “OFF” from “ON” by the operation S13 on the mode switching section 22. This terminates the INT mode, thereby returning to the initial state S0 in which the wipers are not operated. The operation S3 on the mode switching unit 22 can be performed at any time interval setting. In addition, in case that the power of the vehicle is turned “OFF” while the INT mode is “ON”, the INT mode will be in the “OFF” state when the next time the power of the vehicle is turned “ON” (alternatively, it may be configured to remain in the “ON” state, in the same manner as in the first embodiment).

### Modification of the Second Embodiment

As shown in FIG. 10, the lever switch device in the modification of the second embodiment has the “HI” wiper operation setting in a P mode (hence, it is not called the INT mode but the P (program) mode). Then, the switch setting positions of the body part 23 around the first rotation axis L1 of the operating lever 21 are three positions: “OFF”, and “+” and “−” of momentary switches.

It is not limited to adjustment of wiper operation time interval, and it is configured to adjust both time interval and speed of wiper operation. Thus, the setting of wiper operation can be changed from the intermittent operation to a speed of not less than low-speed operation, and even to high-speed operation.

In the modification of the second embodiment, the operation S12 is performed to reduce the time interval of the wiper operation and also to increase the speed of wiper operation. For example, when the operation S12 is performed from the “INT 1” setting, the setting is changed to “LO” at which the time interval of wiper operation is short. When the operation S12 is performed from the “LO” setting, the setting is changed to “HI” at which the speed of wiper operation is fast.

Meanwhile, the operation S11 is performed to increase the time interval the wiper operation and also to change from “HI” to “LO” to reduce the speed of wiper operation.

As described above, the functions and effects described in the first embodiment can be also obtained in the second embodiment in which, instead of the multiple sensitivity levels in the AUTO mode, the multiple degrees of wiper operation, such as time interval and speed of wiper operation, in the same system are arranged to follow an increase or decrease in wiper operation.

In this regard, when the alternate-type “LO” and “HI” switches are omitted and all wiper operation speed adjustments are included in a mode as in the modification of the second embodiment, all operations can be performed from the home position.

Although the embodiments of the invention have been described, the invention is not limited to each of the embodiments described above, and various omissions, substitutions and changes, etc., can be made without departing from the gist of the invention. For example, there are seven levels of AUTO mode sensitivity in the first embodiment, it is not limited thereto. In addition, the P mode in which intermittent operation setting has three levels has been described in the modification of the second embodiment, it is not limited thereto. For example, the intermittent operation setting may have more levels. In addition, a wiper operation speed setting faster than “LO” and slower than “HI” may be further provided between “HI” and “LO”.

In addition, although both time interval adjustment and speed adjustment of wiper operation are performed in the P mode in the modification of the second embodiment, it may be configured such that only speed adjustment of wiper operation is performed.

In addition, not all combinations of the features described in these embodiments are necessary to solve the problem of the invention. Further, these embodiments and modifications thereof are included within the scope and gist of the invention and also within the invention described in the claims and the range of equivalency.

### REFERENCE SIGNS LIST

20 LEVER SWITCH DEVICE
21 OPERATING LEVER
21c INDICATOR LAMP
22 MODE SWITCHING UNIT
23 MAIN BODY
24 CONTROL UNIT

1. A lever switch device which is configured to be connected to a support body in a vehicle, the lever switch device comprising:
a rotatable operating lever,
a switch structure comprising setting positions and allowing wiper operation setting to be made by rotation of the operating lever; and
a structure of a detent mechanism to cause the operating lever to stay in a predetermined position,
wherein the setting positions comprise a home position, a position for wiper operation up adjustment and a position for wiper operation down adjustment, and
wherein the detent mechanism comprises a mechanism to return the operating lever to the home position from the position for wiper operation up adjustment or the position for wiper operation down adjustment.

2. The lever switch device according to claim 1, wherein the position for wiper operation up adjustment and the position for wiper operation down adjustment position are positions to adjust AUTO mode sensitivity.

3. The lever switch device according to claim 1, wherein the position for wiper operation up adjustment and the position for wiper operation down adjustment are positions to adjust time interval of wiper operation.

4. The lever switch device according to claim 3, wherein the positions to adjust time interval of wiper operation comprise a position for low-speed wiper operation setting.

5. The lever switch device according to according to claim 4, wherein the positions to adjust time interval of wiper operation comprise a position for high-speed wiper operation setting.

6. The lever switch device according to claim 1, wherein the setting positions further comprise a position for high-speed wiper operation setting, and wherein the position for wiper operation up adjustment or the position for wiper operation down adjustment is provided between the home position and the position for high-speed wiper operation setting.

7. The lever switch device according to claim 1, further comprising:
a mode switching unit that enables/disables the wiper operation up adjustment or the wiper operation down adjustment.

8. The lever switch device according to claim 5, wherein the mode switching unit enables/disables the wiper operation up adjustment or the wiper operation down adjustment when a push switch provided on a tip portion of the operating lever is changed into a protruding state or a non-protruding state.

9. The lever switch device according to claim 7, further comprising:
a function to indicate a state of the mode switching unit.

10. The lever switch device according to claim 1, further comprising:
a control unit to control wiper operation based on a signal from the switch structure.
